(19) United States
(12) Patent Application Publication
(10) Pub. No.: US 2015/0344347 A1
(43) Pub. Date: Dec. 3, 2015

(54) APPARATUSES FOR STEERING FLEXIBLE GLASS WEBS AND METHODS FOR USING THE SAME

(71) Applicant: Corning Incorporated, Corning, NY (US)

(72) Inventors: Todd Benson Fleming, Elkland, PA (US); David Joseph Kuhn, Prattsburgh, NY (US); Dale Charles Marshall, Brockport, NY (US); Gary Edward Merz, Rochester, NY (US); John Earl Tosch, Wellsburgh, NY (US); Ian David Tracy, Corning, NY (US); Matthew Daniel Trosa, Corning, NY (US)

(21) Appl. No.: 14/722,548

(22) Filed: May 27, 2015

Related U.S. Application Data
(60) Provisional application No. 62/004,461, filed on May 29, 2014.

(51) Int. Cl. C03B 35/16; B65H 23/038; C03B 17/06; B65H 23/02

(52) U.S. Cl. CPC C03B 35/164; B65H 23/0208; B65H 23/0204; B65H 23/038; C03B 35/167; C03B 17/068; C03B 17/064; C03B 2225/02

(57) ABSTRACT

In one embodiment a method of steering a glass web includes directing the glass web in a conveyance direction on a web conveyance pathway, contacting at least one surface of the glass web with at least one wheel of at least one idler roller, the at least one wheel of the at least one idler roller having an axis of rotation parallel to a surface of the glass web, detecting an angle between a centerline of the glass web and the conveyance direction with an angle measurement device, and modifying an orientation of the at least one idler roller and the at least one wheel about an axis of rotation substantially orthogonal to the web conveyance pathway to shift the glass web based on a detected angle between the centerline of the glass web and the conveyance direction of the web conveyance pathway.

### CROSS-REFERENCE TO RELATED APPLICATIONS

This application claims the benefit of priority under 35 U.S.C. §119 of U.S. Provisional Application Ser. No. 62/004,461 filed on May 29, 2014, the content of which is relied upon and incorporated herein by reference in its entirety.

### BACKGROUND

1. Field

The present specification generally relates to apparatuses and methods for steering and/or conveying flexible webs and, more specifically, to apparatuses and methods used to steer flexible glass webs during manufacturing.

2. Technical Background

Thin, flexible glass webs can be used in various applications, including so-called “e-paper,” color filters, photovoltaic cells, displays, OLED lighting, and touch sensors. The glass for such substrates can be quite thin, typically less than about 0.3 mm. The processing of the substrates can be performed on an individual glass sheet basis, or most efficiently, by conveying the substrate as a long glass web, which can be wound on a roll or spool. Such methods include conveying newly formed glass webs to a glass manufacturing apparatus, processing the glass web, and then winding the glass web onto a take-up roll. Alternatively, the glass web can be singulated into discrete components or sheets instead of the final winding onto a take-up roll.

One drawback to processing glass webs and winding the glass webs on a take up roll is the brittleness of the thin glass web. Specifically, mechanical contact of the glass web during handling can lead to damage, including scratches, chipping, and fracture. The problems may be exacerbated if the web is misaligned during processing and winding, which misalignments may necessitate corrective measures.

Accordingly, there is a need for apparatuses and methods to steer the glass webs as the glass webs are conveyed through the manufacturing operations

### SUMMARY

According to one embodiment, a steering device for steering a glass web includes at least one idler roller positioned adjacent a web conveyance pathway extending through the steering device, the at least one idler roller comprising at least one wheel positioned to engage a surface of the glass web drawn over the web conveyance pathway, the at least one wheel having an axis of rotation which is substantially parallel to the web conveyance pathway, wherein the at least one idler roller is rotatable about an axis of rotation substantially orthogonal to the web conveyance pathway, an actuator coupled to the at least one idler roller to rotate the at least one idler roller about the axis of rotation of the at least one idler roller, an angle measurement device positioned proximate to the web conveyance pathway, the angle measurement device detecting an angle between a centerline of the glass web conveyed on the web conveyance pathway and a conveyance direction of the web conveyance pathway, and an electronic controller communicatively coupled to the actuator and the angle measurement device, the electronic controller comprising a processor and a memory storing a computer readable instruction set, wherein, when the electronic controller executes the computer readable instruction set, the electronic controller detects the angle between the centerline of the glass web and the conveyance direction with the angle measurement device, and commands the actuator to modify an orientation of the at least one idler roller about the axis of rotation of the at least one idler roller based on a detected angle between the centerline of the glass web and the conveyance direction.

In another embodiment, a method of steering a glass web includes directing the glass web in a conveyance direction on a web conveyance pathway, contacting at least one surface of the glass web with at least one wheel of at least one idler roller, the at least one wheel of the at least one idler roller having an axis of rotation parallel to a surface of the glass web, detecting an angle between a centerline of the glass web and the conveyance direction with an angle measurement device, and modifying an orientation of the at least one idler roller and the at least one wheel about an axis of rotation substantially orthogonal to the web conveyance pathway to shift the glass web based on a detected angle between the centerline of the glass web and the conveyance direction of the web conveyance pathway.

In yet another embodiment, a method for producing a glass web includes melting glass batch materials to form molten glass, forming the molten glass into the glass web with a fusion draw machine comprising an inlet, a forming vessel, and a pull roll assembly, drawing the glass web through the pull roll assembly, directing the glass web in a conveyance direction on a web conveyance pathway, contacting at least one surface of the glass web with at least one wheel of an idler roller, the at least one wheel of the idler roller having an axis of rotation parallel to a surface of the glass web, detecting an angle between a centerline of the glass web and the conveyance direction with an angle measurement device, and modifying an orientation of the idler roller and the at least one wheel about an axis of rotation substantially orthogonal to the web conveyance pathway to shift the glass web based on a detected angle between the centerline of the glass web and the conveyance direction of the web conveyance pathway.

Additional features and advantages of the embodiments will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 schematically depicts a side view of a glass manufacturing apparatus having a steering device for controlling the lateral position of a glass web according to one or more embodiments shown or described herein;

FIG. 2 schematically depicts a top view of a glass manufacturing apparatus having a steering device for controlling the lateral position of a glass web according to one or more embodiments shown or described herein;

FIG. 3 schematically depicts a block diagram of a glass manufacturing apparatus having a steering device for controlling the lateral position of a glass web according to one or more embodiments shown or described herein;

FIG. 4 depicts an idler roller of a steering device according to one or more embodiments shown or described herein;

FIG. 5 depicts an angle measurement device of a steering device according to one or more embodiments shown or described herein;

FIG. 6 schematically depicts a top view of a glass manufacturing apparatus with a steering device being used to control the lateral position of a glass web according to one or more embodiments shown or described herein

FIG. 7 schematically depicts a top view of a glass manufacturing apparatus with a steering device being used to control the lateral position of a glass web according to one or more embodiments shown or described herein;

FIG. 8 schematically depicts a top view of a glass manufacturing apparatus with a steering device being used to control the lateral position of a glass web according to one or more embodiments shown or described herein; and

FIG. 9 schematically depicts a glass production apparatus including a steering device according to one or more embodiments shown or described herein.

### DETAILED DESCRIPTION

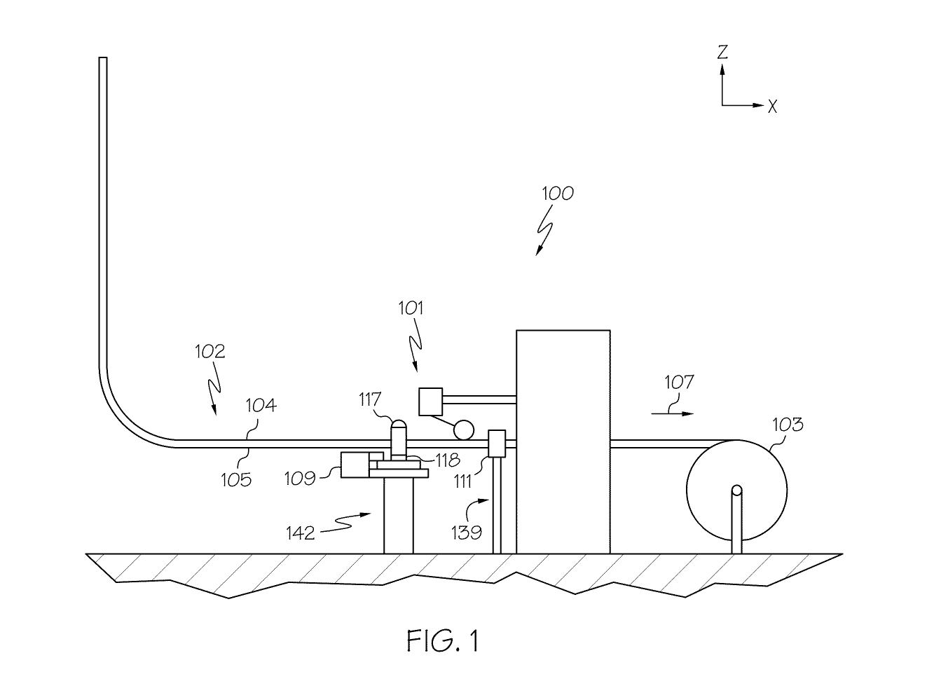

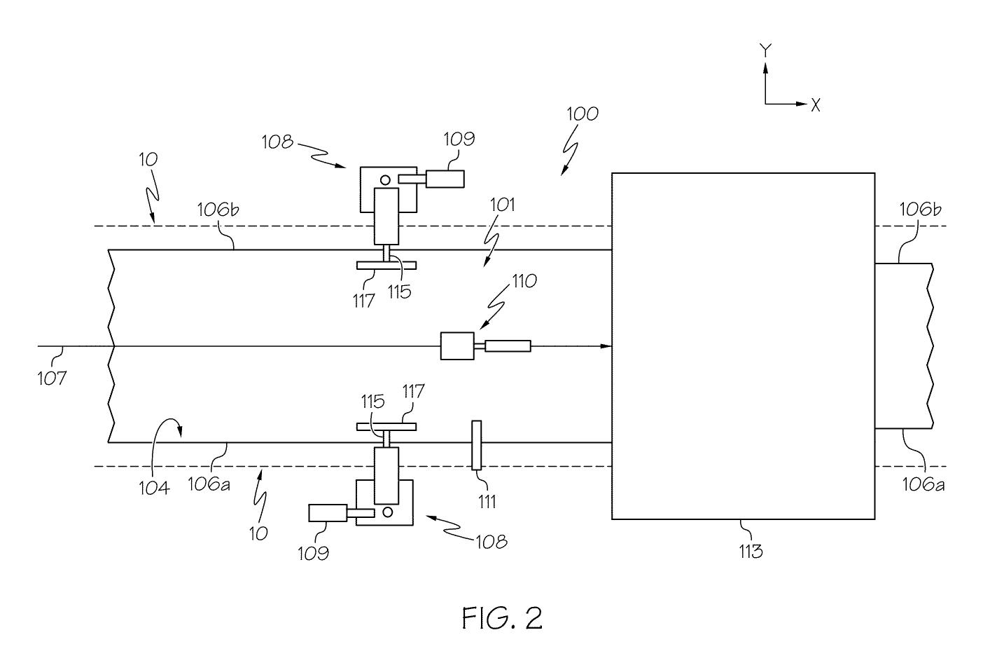

Reference will now be made in detail to embodiments of apparatuses and methods for steering glass webs as the glass webs are conveyed through various manufacturing operations. Whenever possible, the same reference numerals will be used throughout the drawings to refer to the same or like parts. FIGS. 1 and 2 schematically depict one embodiment of a web conveying apparatus with a steering device for steering a continuous web, such as a flexible glass web. The steering device generally includes at least one idler roller, an actuator mechanically coupled to the at least one idler roller, and an angle measurement device. The glass web is generally directed on a web conveyance pathway in a conveyance direction such that the at least one idler roller is in contact with the glass web. As the glass web is drawn in the conveyance direction, the angle measurement device detects an angle between the glass web and the conveyance direction. Based on the detected angle between the glass web and the conveyance direction, an orientation of the at least one idler roller is adjusted in order to bring the glass web into alignment with the conveyance direction of the glass web. For example, as the orientation of the at least one idler roller is adjusted, the contact between the at least one idler roller and the glass web causes the position of the glass web to shift relative to the web conveyance pathway such that the edges of the glass web are substantially parallel with the conveyance direction. Web conveying apparatuses with steering devices and methods for steering glass webs will be described in more detail herein with specific reference to the appended drawings.

The phrase “communicatively coupled” is used herein to describe the interconnectivity of various components of the steering device and means that the components are connected either through wires, optical fibers, or wirelessly such that electrical, optical, and/or electromagnetic signals may be exchanged between the components.

While glass is generally known as a brittle material, inflexible and prone to scratching, chipping and fracture, glass having a thin cross section can in fact be quite flexible. Glass in long thin sheets or webs can be wound and un-wound from rolls, much like paper or plastic film. However, even though glass can be made flexible, it retains its brittle characteristic, and can be damaged by contact.

Maintaining lateral alignment of the glass web as the glass web travels through glass manufacturing equipment may be complicated by misalignment of components of the glass manufacturing equipment. Further, instabilities, perturbations, vibrations, and transient effects that may exist in manufacturing environments or in processing and handling equipment may cause intermittent or extended misalignment of the glass web in the lateral direction to occur. In extreme cases, lateral misalignment of the glass web may lead to fracture.

For example, alignment (or misalignment) between the glass web and glass manufacturing equipment may affect the quality of the processes carried out by the glass manufacturing equipment. In particular, some glass webs are processed by continuously separating thickened edge beads from the glass web. During the bead removal process, the thickened edge beads are separated from the glass web, and the thickened edge beads are conveyed down an alternate path than the glass web. The thickened beads impart stress on the glass web at the point where the glass web is separated from the thickened edge beads. The relative angle between the glass web and the separated thickened edge beads affects the stress at the separation point, and misalignment of the glass web entering the bead separation process can increase the stress at the separation point, potentially causing web breakage.

The apparatuses and methods described provide for steering of the glass web as the glass web is fed through glass manufacturing and processing equipment. Steering the glass web can be used to correct for any such misalignment or camber of the glass web and maintains lateral alignment of the glass web during manufacturing and processing operations.

Referring now to FIGS. 1, 2, and 3, one embodiment of a web conveying apparatus 100 that includes a steering device 101 is schematically depicted. The web conveying apparatus 100 may generally include a conveying mechanism, such as take-up roll 103, and a steering device 101 for maintaining the lateral alignment of a web as the web is conveyed with the web conveying apparatus. The steering device 101 may be used to convey webs of material along a conveyance pathway while maintaining the lateral alignment of the web with respect to the pathway. While the methods and apparatuses are described herein as being used to convey glass webs, it should be understood that the methods and apparatuses may also be used in conjunction with other materials including, without limitation, polymeric materials and/or metallic materials. In the embodiments described herein, the glass web 102 conveyed with the glass conveyance apparatus has a top surface 104, and a bottom surface 105 opposite the top surface 104. The glass web 102 also has opposing lateral edges 106a and 106b which are generally perpendicular to the top surface 104 and the bottom surface 105 of the glass web 102.

In the embodiment of the web conveying apparatus 100 depicted in FIGS. 1-3, simplified representations of a glass web 102 being conveyed with the web conveying apparatus 100 are depicted. Specifically, FIGS. 1-3 schematically depict a glass web being transferred from an upstream manufacturing process, such as a fusion draw process, slot draw process, or the like, to a take-up roll 103. In this embodiment, the glass web 102 is initially drawn from the upstream manufacturing process in a generally vertical direction (i.e., in the +/−Z-direction of the coordinate axes depicted in FIG. 1) and redirected into a substantially horizontal plane (i.e., in a plane substantially horizontal to the plane defined by the +/−X-directions and the +/−Y-directions of the coordinate axes depicted in FIG. 2). In embodiments, the glass web may be redirected from vertical to substantially horizontal using various non-contact web routing devices such as air turns and/or non-contact dancer mechanisms, such as those described in U.S. Pat. No. 8,397,539 assigned to Corning, Inc.

While FIGS. 1 and 2 depict the introduction of the glass web 102 into the web conveying apparatus 100 from an upstream manufacturing process, passing the glass web 102 through the steering device 101, and taking up the glass web 102, it should be understood that other implementations of the web conveying apparatus 100 are contemplated. For example, in some embodiments, the web conveying apparatus 100 may be implemented in roll-to-roll processing of wound glass webs, wherein a formed glass web is unwound from an input spool, processed, and re-wound on a take-up spool.

In embodiments, the web conveying apparatus 100 may optionally include a conveyance mechanism which provides a tractor force to the glass web, thereby drawing the glass web through the steering device 101. For example, in the embodiment of the web conveying apparatus 100 depicted in FIG. 1, the web conveying apparatus 100 includes a take-up roll 103, on which the glass web 102 is collected for removal from the web conveying apparatus 100. The take-up roll 103 may generally comprise a rotating spool or spindle on which the glass web 102 may be wound. In embodiments, the take-up roll 103 may be powered or driven and the speed of rotation of the take-up roll 103 may be varied to achieve a desired rate of conveyance of the glass web 102. For example, in embodiments where the web conveying apparatus 100 is used to convey glass from an upstream forming process, such as the fusion draw process or the like, the speed of rotation of the take-up roll 103 may be varied to coincide with the rate at which the glass is drawn from the upstream forming process. While the web conveying apparatus 100 is depicted in FIG. 1 as comprising a take-up roll 103 as a conveyance mechanism which provides a tractor force to the glass web 102, it should be understood that other conveyance mechanisms are contemplated including, without limitation, powered rollers, powered pinch rollers, and the like.

In the embodiments described herein, the conveyance mechanism of the web conveying apparatus 100 is utilized to draw the glass web 102 in a conveyance direction 107 on a web conveyance pathway 10 which extends through the steering device 101. Referring to FIGS. 1 and 2, in embodiments, the steering device 101 includes at least one idler roller 108 mechanically coupled to an actuator 109, and an angle measurement device 110. For example, in the embodiment of the steering device 101 depicted in FIGS. 1 and 2, the steering device 101 comprises at least one idler roller 108 located at the side of the web conveyance pathway 10 that passes through the steering device 101. The steering device 101 also includes an electronic controller 112 communicatively coupled to the actuator 109 and the angle measurement device 110. The steering device 101 may optionally include an edge sensor 111 communicatively coupled to the electronic controller 112.

In the embodiment of the steering device 101 depicted in FIG. 2, a pair of idler rollers 108 are positioned proximate to opposite edges of the glass web, i.e., one idler roller 108 positioned proximate to edge 106a, and the other idler roller 108 positioned proximate to edge 106b. In embodiments, the at least one idler roller 108 is positioned along the web conveyance pathway 10 such that the at least one idler roller 108 contacts at least one of the top surface 104 or the bottom surface 105 of the glass web 102, as the glass web 102 is conveyed along the web conveyance pathway 10. In embodiments, the idler rollers are positioned to contact the top surface 104 of the glass web 102 as the glass web 102 is conveyed along the web conveyance pathway 10. However, it should be understood that, in alternative embodiments, as shown in FIG. 1, the at least one idler roller 108 may be positioned relative to the web conveyance pathway 10 such that the at least one idler roller 108 contacts the bottom surface 105 of a glass web 102 drawn over the web conveyance pathway 10. In yet other embodiments (not shown), a plurality of idler rollers may be disposed along the web conveyance pathway 10 to contact a glass web 102 drawn over the web conveyance pathway 10 on both the top surface 104 and the bottom surface 105 of the glass web 102.

Referring to FIGS. 2, 3, and 4, an idler roller 108 and an actuator 109 of the steering device 101 are schematically depicted. The idler roller 108 is mechanically coupled to the actuator 109, and the idler roller 108 and the actuator 109 are disposed on the web conveying apparatus 100 proximate to the web conveyance pathway 10. For example, the idler roller 108 and the actuator 109 may be mounted to a frame 142 positioned adjacent to the web conveyance pathway 10, the frame 142 being fixed relative to the web conveyance pathway 10. In alternative embodiments, the idler roller 108 and the actuator 109 may be coupled to a glass manufacturing apparatus (not depicted) through which the web conveyance pathway 10 is directed.

The idler roller 108 includes a body 114, a first shaft 115 and a second shaft 116 mechanically coupled to the body 114, and a first wheel 117 and a second wheel 118 mechanically coupled to the first shaft 115 and the second shaft 116, respectively. The first wheel 117 and the second wheel 118 are configured to be rotatable with respect to the body 114 of the idler roller 108 about the first shaft 115 and the second shaft 116, respectively. The first shaft 115 and the second shaft 116 define axes of rotation for the first wheel 117 and the second wheel 118. In embodiments described herein, the axes of rotation of the first wheel 117 and the second wheel 118 are substantially parallel to the web conveyance pathway 10. Under normal operating conditions, the axis of rotation of the first wheel 117 and the second wheel 118 are nominally perpendicular to the web conveyance direction 107. However it should be understood that the axis of rotation of the first wheel 117 and the second wheel 118 may be adjusted with respect to the web conveyance direction 107 to shift the glass web 102, as will be described in greater detail herein. In alternative embodiments the idler roller 108 may include a single shaft mechanically coupled to the body 114, and a single wheel connected to the shaft.

In embodiments described herein, the idler roller 108 is positioned relative to the web conveyance pathway 10 such that the web conveyance pathway 10 passes between the first wheel 117 and the second wheel 118. As such, it should be understood that the first wheel 117 and the second wheel 118 are located on opposite sides of the glass conveyance pathway 10 in the +/−Z-direction of the coordinate axes depicted in FIG. 1. For example, the first wheel 117 of the idler roller 108 is positioned to engage the top surface 104 of the glass web 102 as the glass web 102 is drawn over the web conveyance pathway 10. The second wheel 118 of the idler roller 108 is positioned to engage the bottom surface 105 of the glass web 102 as the glass web 102 is drawn over the web conveyance pathway 10. As depicted in FIG. 1, the idler roller 108 of the steering device 101 is pivotally attached to a frame 142 that is fixed proximate to the web conveyance pathway 10 such that the first wheel 117 and the second wheel 118 of the idler roller 108 are rotatable with respect to the web conveyance pathway 10 about axis 119.

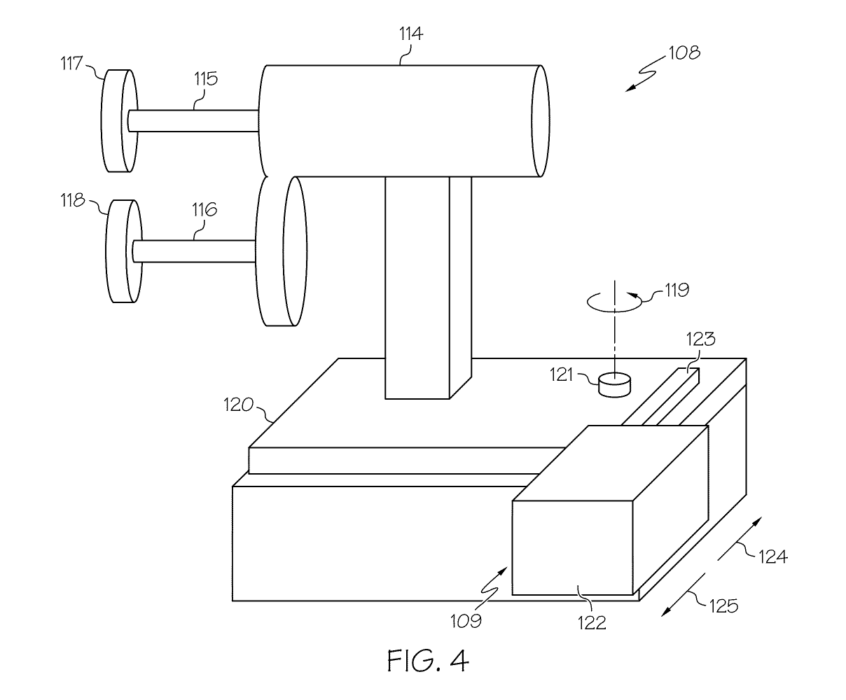

In embodiments, the idler roller 108 includes a bracket 120 that is fixedly coupled to the body 114. The body 114 is pivotally attached to the frame 142, such as by a pin 121 or a similar fastener, such that the bracket 120 pivots about axis 119, where axis 119 is substantially orthogonal to the web conveyance pathway 10. As the bracket 120 rotates about axis 119, the body 114, and subsequently the first wheel 117 and the second wheel 118, rotate about axis 119 with respect to the web conveyance pathway 10, and thus rotate with respect to the conveyance direction 107 of the glass web 102 drawn over the web conveyance pathway 10. While the embodiment depicted in FIG. 4 includes a bracket 120 connected to the frame 142 by a pin 121, other apparatuses for pivotally connecting the idler roller 108 to the frame 142 are contemplated, including but not limited to bearings, and the like.

In embodiments, the first wheel 117 and the second wheel 118 of the idler roller 108 are rotated about their respective shafts through contact with the glass web 102, as the glass web 102 is directed in the conveyance direction 107 over the web conveyance pathway 10. In some embodiments, the first wheel 117 and the second wheel 118 of the idler roller 108 are not powered, but freely rotate as a result of the first wheel 117 and the second wheel 118 being in contact with the moving glass web 102. In alternative embodiments, the first wheel 117 and/or the second wheel 118 may be driven such that the first wheel 117 and/or the second wheel 118 rotate at the same speed as the glass web 102, as the glass web 102 is conveyed in the conveyance direction 107. The first wheel 117 and/or the second wheel 118 may be driven by power sources including, but not limited to, pneumatically driven spindles, electric motors, and the like.

The actuator 109 of the steering device 101 is mechanically coupled to the at least one idler roller 108, such that the actuator 109 may manipulate and pivot the idler roller 108 about the axis 119. In the embodiment depicted in FIG. 4, the actuator 109 is mechanically coupled to the bracket 120 of the idler roller 108, such that the actuator pivots the bracket 120 about the axis 119, altering the orientation of the idler roller 108 with respect to the web conveyance pathway 10. The actuator 109 includes a body 122 and an extendable shaft 123 which may be transitioned between an extended position 124 and a retracted position 125 with respect to the body 114 of the actuator 109, including positions intermediate between the extended position and the retracted position. When the extendable shaft 123 of the embodiment depicted in FIG. 4 is moved to the extended position 124, the bracket 120, and subsequently the idler roller 108, is pivoted in a counter-clockwise direction about axis 119. When the extendable shaft 123 of the embodiment depicted in FIG. 4 is moved to the retracted position 125, the bracket 120, and subsequently the idler roller 108, is pivoted in a clockwise direction about axis 119. As the idler roller 108 is pivoted in the counter-clockwise direction or the clockwise direction, the first wheel 117 and the second wheel 118 of the idler roller 108 are pivoted with respect to the web conveyance pathway 10. While the actuator 109 shown in FIG. 4 is affixed to the frame 142 such that the extendable shaft 123 pivots the idler roller 108 in the counter-clockwise direction when the extendable shaft 123 is moved towards the extended position 124, it should be understood that the actuator 109 may be mounted such that the extendable shaft 123 pivots the idler roller 108 in the clockwise direction when the extendable shaft 123 is moved towards the extended position 124. Similarly, while the actuator shown in FIG. 4 is mounted to the web conveying apparatus 100 such that the extendable shaft 123 pivots the idler roller 108 in the clockwise direction when the extendable shaft 123 is moved towards the retracted position 125, it should be understood that the actuator 109 may be mounted to the web conveying apparatus 100 such that the idler roller 108 pivots in the counter-clockwise direction when the extendable shaft 123 is moved towards the retracted position 125.

In embodiments, the actuator 109 may be a pneumatic device such as a pneumatic air cylinder, using air pressure to move the extendable shaft 123 between the extended position 124 and the retracted position 125. Alternatively, the actuator may be a linear actuator, a hydraulic actuator or any other actuator suitable for imparting linear and/or rotational motion to a component.

For example, while the embodiment of the steering device 101 depicted in FIG. 4 shows an actuator 109 that pivots the idler roller 108 by extending or retracting an extendable shaft 123, other actuators to pivot the idler roller 108 are contemplated. Other contemplated actuators (not depicted) include, but are not limited to, actuators including a rotating shaft mechanically coupled to the idler roller where the rotating shaft pivots the idler roller 108 with respect to the web conveyance pathway 10. The rotating shaft may be mechanically coupled to the idler roller 108 so as to pivot the idler roller 108 by conventional mechanical assemblies, including but not limited to a ball screw assembly, a gear assembly, a rack and pinion assembly, or by direct connection to the idler roller 108.

In embodiments, the actuator 109 is communicatively coupled to an electronic controller 112. The actuator 109 may be configured to receive signals from the electronic controller 112, for instance signals commanding the actuator 109 to advance the extendable shaft 123 towards the extended position 124 or to advance the extendable shaft 123 towards the retracted position 125, to pivot the idler roller 108. The actuator 109 may also be configured to send signals to the electronic controller 112 such as, for example, signals indicating a position of the extendable shaft 123 and/or the orientation of idler roller 108.

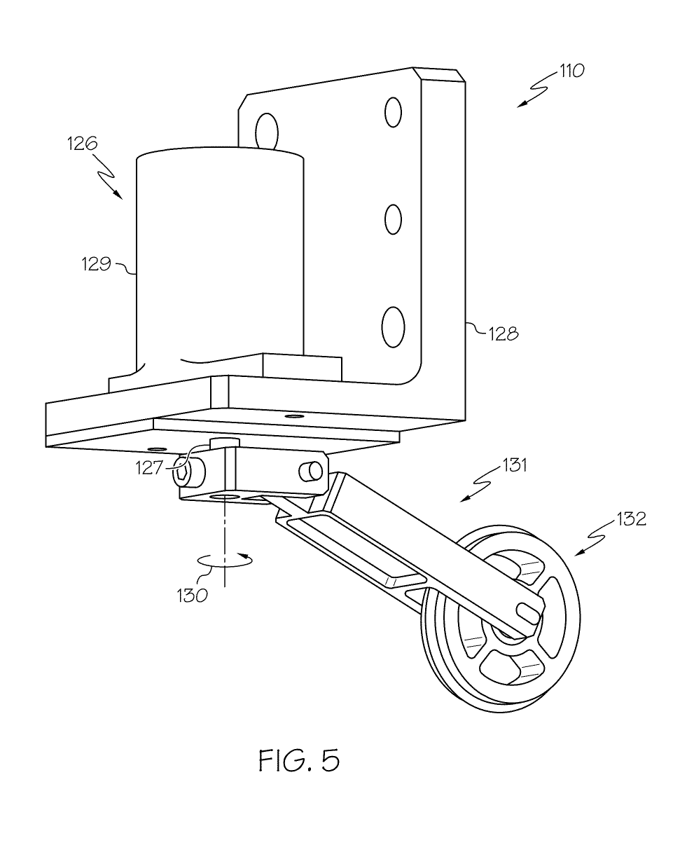

Referring to FIGS. 1, 2, 3, and 5, in embodiments, the steering device 101 of the web conveying apparatus 100 further includes an angle measurement device 110. The angle measurement device 110 is utilized to determine an angular orientation of the glass web 102 relative to the conveyance direction 107 as the glass web 102 is conveyed over the web conveyance pathway 10. The angle measurement device 110 is positioned proximate to the web conveying apparatus 100 proximate to a surface of the glass web 102. The location of the angle measurement device 110 may be fixed relative to the web conveyance pathway 10, with the angle measurement device 110 cantilevered over the web conveyance pathway 10, as shown in FIG. 1. The angle measurement device 110 includes an angular displacement sensor 126 having a housing 129 and a shaft 127. The shaft 127 of the angular displacement sensor 126 may be fixed to the housing 129 by a stator (not shown). In embodiments, the angular displacement sensor 126 is a rotary variable differential transformer (RVDT). In alternative embodiments, the angular displacement sensor 126 may be a rotary variable inductive transducer (RVIT), a magnetic encoder, or any other suitable rotary sensor known in the art. In one embodiment the angle displacement sensor may be a Positek RVDT available from Positek Ltd., Chetlenham, UK.

The angular displacement sensor 126 is mechanically coupled to a frame 128 positioned proximate to the glass web 102. For example, in some embodiments, the frame 128 may be cantilevered over the web conveyance pathway 10, such that the frame 128 is fixed relative to the web conveyance pathway 10. The shaft 127 is freely rotatable with respect to the housing 129 of the angular displacement sensor 126 about an axis 130.

In embodiments, the angle measurement device 110 includes a trailing arm 131 that is mechanically coupled to the shaft 127 of the angular displacement sensor 126 such that the trailing arm 131 and the extendable shaft 123 rotate about axis 130 with respect to the frame 128. The trailing arm 131 includes a caster 132 which contacts the top surface 104 of the glass web 102, as schematically depicted in FIG. 2. As the caster 132 contacts the top surface 104 of the glass web 102, the caster 132 and trailing arm 131 are free to rotate with respect to the frame 128 such that the caster 132 and the trailing arm 131 track the angular position of the glass web 102 with respect to the frame 128, and thus the angle between the glass web 102 and the conveyance direction 107 of the conveyance pathway 10, as the glass web 102 is conveyed over the web conveyance pathway 10. More specifically, the angle between the caster 132 and the frame 128 is indicative of the angle between the glass web 102 and the conveyance direction 107.

In alternative embodiments, the angular displacement sensor 126 may comprise an optical mouse, acoustic measuring device, or a vision system for measuring an angle of the glass web 102 relative to the conveyance direction 107.

In embodiments, the angle measurement device 110 is communicatively coupled to the electronic controller 112 and configured to send electronic signals to the electronic controller 112, such as the position of the caster 132 of the trailing arm 131 with respect to the frame 128, providing a signal that is indicative of the angle between the glass web 102 and the conveyance direction 107.

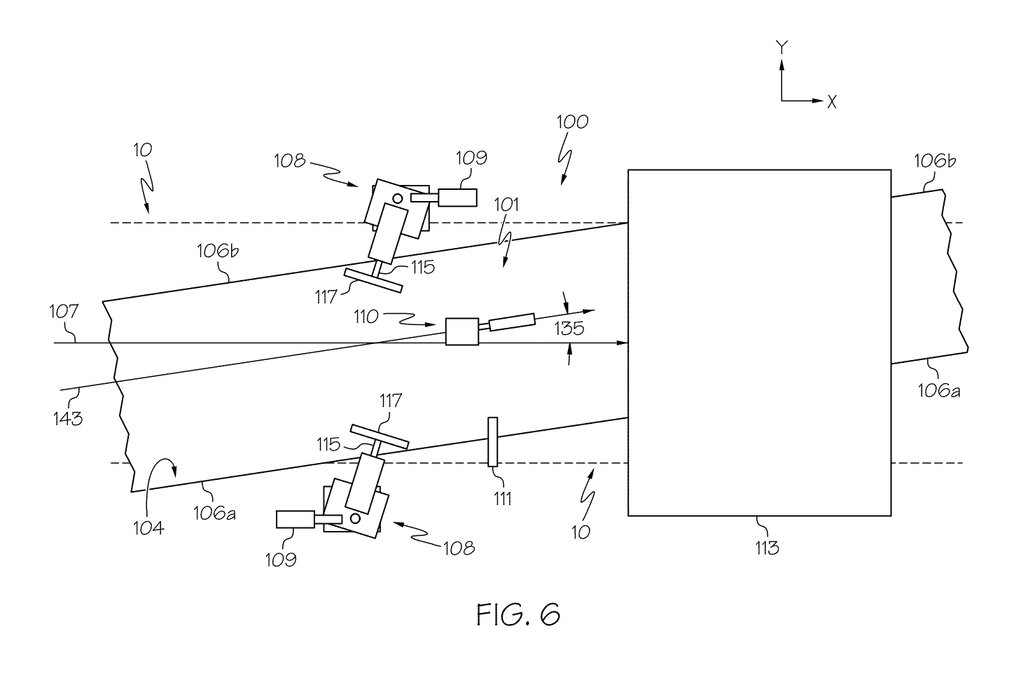

Referring to FIG. 6, in some embodiments, the steering device 101 may optionally include an edge sensor 111. The edge sensor 111 is disposed on the web conveying apparatus 100 at a position proximate to one of edge 106a or 106b of the glass web 102. In embodiments, the edge sensor may be mounted to a frame 139 proximate to the web conveyance pathway 10. The edge sensor 111 is positioned proximate detects a position of one of edge 106a or 106b of the glass web 102 in a direction orthogonal to the conveyance direction 107. In one embodiment, the edge sensor 111 may be a WideArray Edge Detector available from AccuWeb, Inc. of Madison, Wis. However, in other embodiments, the edge sensor 111 may include a photo array sensor, proximity sensor, or other sensors suitable for detecting the edge of a glass sheet. The edge sensor 111 may be communicatively coupled to the electronic controller 112 and configured to provide a signal indicative of the position of one of edge 106a or 106b of the glass web 102 in a direction orthogonal to the conveyance direction 107 of the glass web 102 over the web conveyance pathway 10.

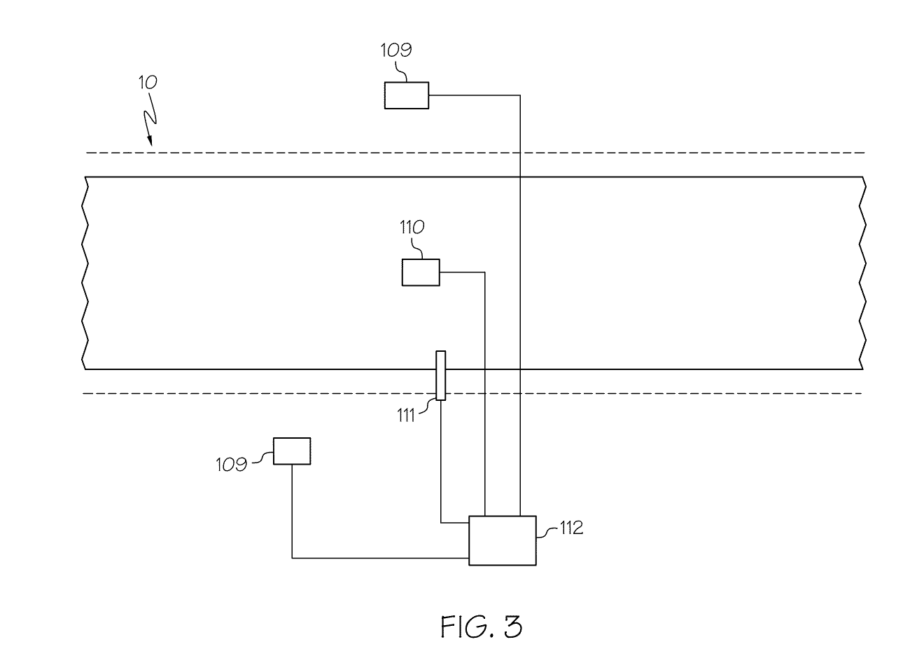

Referring again to FIG. 3, the electronic controller 112 interconnects the various electrical components of the steering device 101 and also controls the angular orientation of the at least one idler roller 108 with respect to the web conveyance pathway 10 based on signals received from at least the angle measurement device 110. For example, the electronic controller 112 may be communicatively coupled to the actuator 109, the angle measurement device 110, and the edge sensor 111. The electronic controller 112 includes a processor and a memory storing a computer readable instruction set, which, when executed by the processor, facilitates operation of the steering device 101, as will be described in further detail herein.

Turning now to FIGS. 1, and 2, in operation, the glass web 102 is initially drawn in a conveyance direction 107 over the web conveyance pathway 10 which is substantially parallel to the X-Y plane defined by the coordinate axes depicted in FIG. 2. In the embodiment shown in FIGS. 1 and 2, the glass web 102 is drawn in the conveyance direction 107 by rotation of the take-up roll 103 which draws the glass web 102 through the steering device 101.

Referring to FIG. 6, as the glass web 102 is conveyed along the web conveyance pathway 10, the glass web 102 may deviate laterally such that the lateral edges 106a and 106b of the glass web 102 are no longer parallel with the conveyance direction 107, as depicted in FIG. 6, and an angle 135 is present between a centerline 143 of the glass web 102 and the conveyance direction 107. The centerline 143 of the glass web 102, as used herein, refers to the imaginary line which is parallel to the lateral edges 106a, 106b, extends in the length direction of the glass web 102 (i.e., in the +/−Y-direction of the coordinate axes depicted in FIG. 6), and evenly bisects the glass web in a width direction of the glass web 102 (i.e., in the +/−X-direction of the coordinate axes depicted in FIG. 6). As the glass web 102 is conveyed over the web conveyance pathway, the caster 132 of the trailing arm 131 of the angle measurement device 110 tracks with the glass web 102 such that the axis of rotation of the caster 132 remains perpendicular to the lateral edges 106a, 106b of the glass web 102. Specifically, as the trailing arm 131 tracks the glass web 102, the trailing arm 131 pivots the shaft 127 of the angular displacement sensor 126 of the angle measurement device 110. In response to the lateral displacement detected by the angular displacement sensor 126, the actuator 109 pivots the at least one idler roller 108 about axis 119 in a direction opposite of the angle 135. As the at least one idler roller 108 is pivoted, the contact between the top surface 104 and the bottom surface 105 of the glass web 102 and the first wheel 117 and second wheel 118 of the idler roller 108, respectively, shifts the glass web to correct the lateral displacement.

More specifically, the angle measurement device 110, and the actuator 109 are communicatively coupled to electronic controller 112, as noted above. As the trailing arm 131 tracks the glass web 102, the trailing arm 131 pivots the shaft 127 of the angular displacement sensor 126 of the angle measurement device 110. The angular displacement sensor 126 of the angle measurement device 110 detects the angle 135 between the centerline 143 of the glass web 102 and the conveyance direction 107 based on the rotation of the shaft 127 and outputs a signal to the electronic controller 112 indicative of this angle. The electronic controller 112 receives the signal from the angle measurement device 110 indicating the angle 135 between the centerline 143 of the glass web 102 and the conveyance direction 107. Upon receiving the signal from the angle measurement device 110, the electronic controller 112 commands the actuator 109 to extend or retract the extendable shaft 123 of the actuator 109 to pivot the idler roller 108 in a direction opposite of the detected angle 135. By pivoting the idler roller 108 in a direction opposite the angle 135 between the glass web 102 and the conveyance direction 107, the first wheel 117 and second wheel 118 of the idler roller 108 are pivoted with respect to the glass web 102 in a direction opposite the angle 135, thereby providing a corrective force to the glass web 102 to shift the glass web such that the centerline 143 of the glass web 102 is aligned with the conveyance direction 107. As the glass web 102 is shifted by the idler roller 108, the angle 135 between the centerline 143 of the glass web 102 and the conveyance direction 107 decreases. As the angle 135 between the centerline 143 of the glass web 102 and the conveyance direction 107 decreases, the angle measurement device 110 sends a signal to the electronic controller 112 indicating the decreased angle 135 between the centerline 143 of the glass web 102 and the conveyance direction 107. When the centerline 143 of the glass web 102 is substantially parallel to the conveyance direction 107, as shown in FIG. 2, the angle measurement device 110 sends a signal to the electronic controller 112 indicating that glass web 102 is substantially parallel to the conveyance direction 107. When the electronic controller 112 receives a signal from the angle measurement device that the glass web 102 is substantially parallel to the conveyance direction 107, the electronic controller 112 commands the actuator 109 to retract or extend the extendable shaft 123 to pivot the idler roller 108 so that the first wheel 117 and the second wheel 118 are substantially parallel with the conveyance direction 107 as shown in FIG. 2.

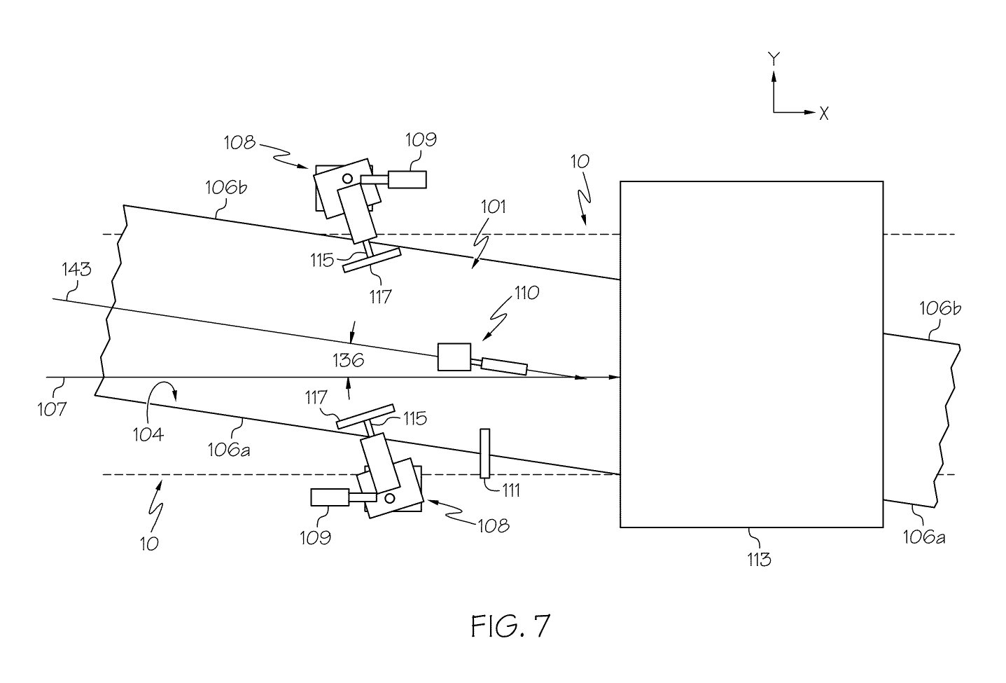

Referring now to FIG. 7, another embodiment of a method for adjusting the lateral displacement of a conveyed web will be described. Similar to the glass web depicted in FIG. 6, the glass web 102 is conveyed in the conveyance direction 107 with an angle 136 between the centerline 143 of the glass web 102 and the conveyance direction 107. The caster 132 of the trailing arm 131 of the angle measurement device 110 tracks the glass web 102, as described above, causing the trailing arm 131 to pivot the shaft 127 of the angular displacement sensor 126 of the angle measurement device 110. To shift the glass web 102 so that the centerline 143 of the glass web 102 is substantially parallel to the conveyance direction 107, the actuator 109 pivots the idler roller 108 in a direction opposite angle 136. By pivoting the idler roller 108 in a direction opposite angle 136, the first wheel 117 and the second wheel 118 of the idler roller 108 contact the top surface 104 and the bottom surface 105 of the glass web 102 at an angle, thereby providing a corrective force to the glass web 102 and shifting the glass web 102.

More specifically, the angle measurement device 110, and the actuator 109 are communicatively coupled to electronic controller 112, as noted above. The angle measurement device 110 detects an angle 136 between centerline 143 of the glass web 102 and the conveyance direction 107. The electronic controller 112 receives a signal from the angle measurement device 110 indicating the angle 136 between the centerline 143 of the glass web 102 and the conveyance direction 107. Upon receiving the signal from the angle measurement device 110, the electronic controller 112 commands the actuator 109 to extend or retract the extendable shaft 123 of the actuator 109 to pivot the idler roller 108 in a direction opposite of the detected angle 135. By pivoting the idler roller 108 in a direction opposite the angle 136 between the centerline 143 of the glass web 102 and the conveyance direction 107, the first wheel 117 and the second wheel 118 of the idler roller 108 provide a corrective force to shift the glass web 102. As the glass web 102 is shifted by the idler roller 108, the angle 136 between the centerline 143 of the glass web 102 and the conveyance direction 107 decreases. As the angle 136 between the centerline 143 of the glass web 102 and the conveyance direction 107 decreases, the angle measurement device 110 sends a signal to the electronic controller 112 indicating the decreased angle 136 between the centerline 143 of the glass web 102 and the conveyance direction 107. When the centerline 143 of the glass web 102 is substantially parallel to the conveyance direction 107, as shown in FIG. 2, the angle measurement device 110 sends a signal to the electronic controller 112 indicating that the centerline of the glass web 102 is substantially parallel to the conveyance direction 107. When the electronic controller 112 receives a signal from the angle measurement device that the centerline 143 of the glass web 102 is substantially parallel to the conveyance direction 107, the electronic controller 112 commands the actuator 109 to retract or extend the extendable shaft 123 to pivot the idler roller 108 so that the first wheel 117 and the second wheel 118 are substantially parallel with the conveyance direction 107, as shown in FIG. 2.

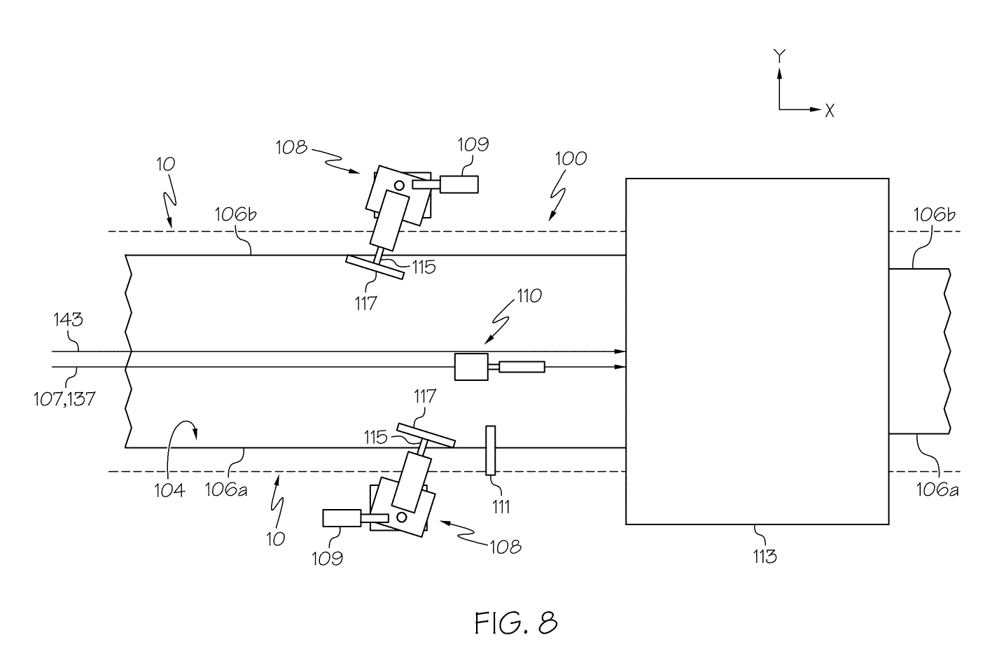

Referring now to FIG. 8, another embodiment of a method for adjusting the lateral displacement of a conveyed web will be described. In the embodiment shown in FIG. 8, the glass web 102 is conveyed such that the centerline 143 of the glass web 102 is substantially parallel to the conveyance direction 107. However, while the centerline 143 of the glass web 102 is substantially parallel to the conveyance direction 107, the centerline 143 of the glass web 102 is offset from a centerline 137 of the web conveyance pathway 10 by a distance 138. In this embodiment, the edge sensor 111 detects a position of one of edge 106a or 106b of the glass web 102. The position of the edge 106a or 106b of the glass web 102 is related to the position of the centerline 143 of the glass web 102 in a direction orthogonal to the conveyance direction 107. If a width w of the glass web 102 is constant, then movement of the lateral edges 106a, 106b in a direction orthogonal to the conveyance direction 107 are indicative of movement of the centerline 143 of the glass web 102 orthogonal to the conveyance direction 107.

To shift the glass web 102 so that the glass web 102 is not offset from the centerline 137 of the web conveyance pathway 10, the actuator 109 pivots the at least one idler roller 108 about axis 119 in a direction to align the centerline 143 of the glass web 102 with the centerline 143 of the web conveyance pathway 10. As the at least one idler roller 108 is pivoted, the contact between the top surface 104 and the bottom surface 105 of the glass web 102 and the first wheel 117 and second wheel 118 of the idler roller 108 respectively, shifts the glass web.

More specifically, the edge sensor 111, and the actuator 109 are communicatively coupled to electronic controller 112. The edge sensor 111 detects a position of one of edge 106a or 106b of the glass web 102 indicating that the centerline 143 of the glass web 102 is offset from the centerline 137 of the web conveyance pathway 10 by a distance 138. The electronic controller 112 receives a signal from the edge sensor 111 indicating the position of the one of edge 106a or 106b of the glass web 102. Upon receiving the signal from the edge sensor 111, the electronic controller 112 commands the actuator 109 to extend or retract the extendable shaft 123 of the actuator 109 to pivot the idler roller 108 in a direction to shift the glass web 102 to reduce the distance 138 between the centerline 143 of the glass web 102 and the centerline 137 of the web conveyance pathway 10. By pivoting the idler roller 108, the first wheel 117 and the second wheel 118 of the idler roller 108 shift the glass web 102. As the glass web 102 is shifted by the idler roller 108, the distance 138 between the glass web 102 and the centerline 137 of the web conveyance pathway 10 is decreased. As the distance 138 between the centerline 143 of the glass web 102 and the centerline 137 of the web conveyance pathway 10 decreases, the edge sensor 111 sends a signal to the electronic controller 112 indicating the movement of the one of edge 106a or 106b of the glass web 102. When the glass web 102 is substantially aligned with the centerline 137 of the web conveyance pathway, as shown in FIG. 2, the edge sensor 111 sends a signal to the electronic controller 112 indicating the position of one of edge 106a or 106b of the glass web 102. When the electronic controller 112 receives a signal from the edge sensor 111 that the one of edge 106a or 106b of the glass web is in a predetermined position indicative of the centerline 137 of the web conveyance pathway 10 and the centerline 143 of the glass web being aligned, the electronic controller 112 commands the actuator 109 to retract or extend the extendable shaft to pivot the idler roller 108 so that the first wheel 117 and the second wheel 118 are substantially parallel with the conveyance direction 107, as shown in FIG. 2.

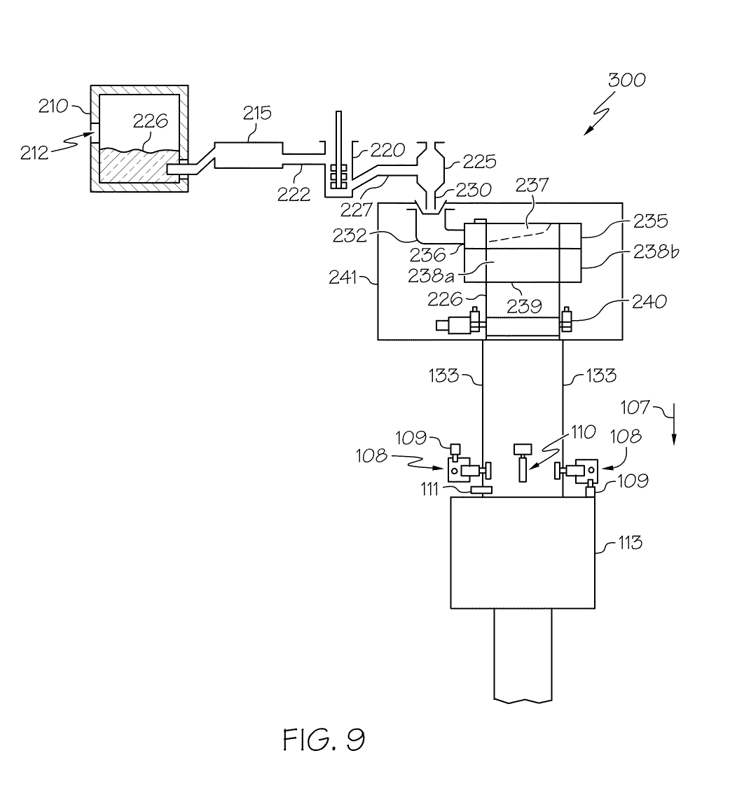

Referring now to FIG. 9, the methods and apparatuses for steering glass webs may be used in conjunction with a glass production apparatus 200 that produces a glass web 102 from glass batch materials. The glass production apparatus 200 may include a melting vessel 210, a fining vessel 215, a mixing vessel 220, a delivery vessel 225, and a fusion draw machine (FDM) 241. Glass batch materials are introduced into the melting vessel 210 as indicated by arrow 212. The batch materials are melted to form molten glass 226. The fining vessel 215 has a high temperature processing area that receives the molten glass 226 from the melting vessel 210 and in which bubbles are removed from the molten glass 226. The fining vessel 215 is fluidly coupled to the mixing vessel 220 by a connecting tube 222. The mixing vessel 220 is, in turn, fluidly coupled to the delivery vessel 225 by a connecting tube 227.

The delivery vessel 225 supplies the molten glass 226 through a downcomer 230 into the FDM 241. The FDM 241 comprises an inlet 232, a forming vessel 235, and a pull roller assembly 240. As shown in FIG. 10, the molten glass 226 from the downcomer 230 flows into the inlet 232 which leads to the forming vessel 235. The forming vessel 235 includes an opening 236 that receives the molten glass 226 which flows into a trough 237 and then overflows and runs down two sides 238a and 238b before fusing together below a root 239. The two sides 238a and 238b of the forming vessel 235 come together such that the two overflow walls of molten glass 226 rejoin (e.g., fuse) before being drawn downward by the pull roller assembly 240 to form the glass web 102. As the glass web 102 remains in a viscous or visco-elastic state, the glass web 102 is prone to dimensional variations. To control the dimensional variation of the glass web 102, the pull roller assembly 240 “draws” the glass web 102, or applies tension to the glass web 102 as the glass web 102 continues to form from the forming vessel 235. As such, as used herein, “draw” refers to moving the glass web 102 through a glass production apparatus 200 while the glass web 102 is in a viscous or visco-elastic state. The glass web 102 goes through a visco-elastic transition in a “setting zone” in which the stress and flatness are set into the glass web 102, and the glass web 102 transitions to a more elastic state.

As the glass web 102 exits the pull roller assembly 240, the glass web 102 is in an elastic state. In one embodiment, after the glass web 102 passes through the setting zone, the glass web 102 may be conveyed into a glass processing machine 113, such as a bead removal machine, which removes thickened edge beads 133 formed on the glass web 102 during the formation process by laser or mechanical separation. In the case where the glass processing machine 113 is a bead removal machine, the effectiveness of the bead removal machine in removing thickened edge beads 133 from the glass web 102 directly relates to the angular alignment between the glass web 102 and the conveyance direction 107. For example, when the glass web 102 is laterally misaligned on the web conveyance pathway relative to the conveyance direction 107, an angle 135 between the centerline 143 of the glass web 102 and the conveyance direction 107 may exist as depicted in FIG. 6 (the angle 135 depicted in FIG. 6 is exaggerated for purposes of illustration). When this misalignment occurs, the edge beads may not accurately and evenly removed from the edges of glass web, potentially resulting in significant manufacturing losses as portions of the glass web are discarded for being “out of spec”. However, the lateral location of the glass web 102 can be controlled by a steering device 101 which facilitates the accurate removal of the thickened edge beads 133 and a reduction in manufacturing losses.

Accordingly, as the glass web 102 exits the pull roller assembly 240 in the conveyance direction 107, the glass web 102 is directed into the steering device 101. The steering device 101 includes an angle measurement device 110 that determines an angle between the glass web 102 and the conveyance direction 107, as described above. The at least one idler roller 108 of the steering device 101 is pivoted such that the angular position of the glass web 102 is maintained and evenly controlled as the glass web 102 enters the glass processing machine 113.

By sensing the angle between the glass web and the conveyance direction with an angle measurement device, the steering device is able to sense the angular alignment of the glass web with the web conveyance pathway. Steering the glass web so that the glass web is angularly aligned with the web conveyance pathway may reduce web breakage and generally improve the alignment of the web with respect to glass processing apparatuses, such as coaters, bead removal machines, and the like. The angle measurement device of the steering device allows the steering device to detect an angle between the glass web and the conveyance direction which may not be detected by an edge sensor alone. Because an edge sensor only detects the position of an edge of the glass web at a single point, an edge sensor may fail to detect angular misalignment between the glass web and glass processing machine.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

What is claimed is:

1. A steering device for steering a glass web, the steering device comprising:
at least one idler roller positioned adjacent a web conveyance pathway extending through the steering device, the at least one idler roller comprising at least one wheel positioned to engage a surface of the glass web drawn over the web conveyance pathway, the at least one wheel having an axis of rotation which is substantially parallel to the web conveyance pathway, wherein the at least one idler roller is rotatable about an axis of rotation substantially orthogonal to the web conveyance pathway;
an actuator coupled to the at least one idler roller to rotate the at least one idler roller about the axis of rotation of the at least one idler roller;
an angle measurement device positioned proximate to the web conveyance pathway, the angle measurement device detecting an angle between a centerline of the glass web conveyed on the web conveyance pathway and a conveyance direction of the web conveyance pathway; and
an electronic controller communicatively coupled to the actuator and the angle measurement device, the electronic controller comprising a processor and a memory storing a computer readable instruction set, wherein, when the electronic controller executes the computer readable instruction set, the electronic controller:
detects the angle between the centerline of the glass web and the conveyance direction with the angle measurement device; and
commands the actuator to modify an orientation of the at least one idler roller about the axis of rotation of the at least one idler roller based on a detected angle between the centerline of the glass web and the conveyance direction.

2. The steering device of claim 1, wherein the electronic controller commands the actuator to modify the orientation of the at least one idler roller about the axis of rotation of the at least one idler roller such that the centerline of the glass web is substantially parallel to the conveyance direction.

3. The steering device of claim 1, wherein the at least one wheel of the at least one idler roller contacts a top surface of the glass web on the web conveyance pathway proximate to an edge of the glass web.

4. The steering device of claim 1, wherein the at least one idler roller comprises a first wheel and a second wheel, wherein the first wheel of the at least one idler roller contacts a top surface of the glass web proximate to an edge of the glass web, and the second wheel of the at least one idler roller contacts a bottom surface of the glass web proximate to the edge of the glass web.

5. The steering device of claim 1, wherein the actuator is a pneumatic air cylinder.

6. The steering device of claim 1, further comprising an edge sensor positioned proximate to an edge of the glass web for detecting a position of the edge of the glass web in a direction orthogonal to the conveyance direction, wherein the electronic controller is communicatively coupled to the edge sensor, and wherein, when the electronic controller executes the computer readable instruction set, the electronic controller:
detects the angle between the glass web and the conveyance direction with the angle measurement device;
detects a position of the edge of the glass web with the edge sensor; and
commands the actuator to modify the orientation of the at least one idler roller about the axis of rotation of the at least one idler roller based on the detected angle between the centerline of the glass web and the conveyance direction, and the position of the edge of the glass web.

7. The steering device of claim 6, wherein the electronic controller commands the actuator to modify the orientation of the at least one idler roller about the axis of rotation of the at least one idler roller such that the centerline of the glass web is substantially parallel to the conveyance direction, and the edge of the glass web is adjusted to a predetermined position.

8. A method of steering a glass web comprising:
directing the glass web in a conveyance direction on a web conveyance pathway;
contacting at least one surface of the glass web with at least one wheel of at least one idler roller, the at least one wheel of the at least one idler roller having an axis of rotation parallel to a surface of the glass web;
detecting an angle between a centerline of the glass web and the conveyance direction with an angle measurement device; and
modifying an orientation of the at least one idler roller and the at least one wheel about an axis of rotation substantially orthogonal to the web conveyance pathway to shift the glass web based on a detected angle between the centerline of the glass web and the conveyance direction of the web conveyance pathway.

9. The method of steering a glass web of claim 8, wherein the orientation of the at least one wheel and the at least one idler roller are modified such that the centerline of the glass web is substantially parallel to the conveyance direction.

10. The method of steering a glass web of claim 8, wherein the at least one wheel of the at least one idler roller contacts a top surface of the glass web proximate to an edge of the glass web.

11. The method of steering a glass web of claim 8, wherein the at least one idler roller comprises a first wheel that contacts a top surface of the glass web proximate to an edge of the glass web, and a second wheel that contacts a bottom surface of the glass web proximate to the edge of the glass web.

12. The method of steering a glass web of claim 8, further comprising detecting a position of an edge of the glass web, and modifying the orientation of the at least one idler roller and the at least one wheel to shift the glass web based on the detected angle between the centerline of the glass web and the conveyance direction of the web conveyance pathway and a detected position of the edge of the glass web.

13. The method of steering a glass web of claim 12 wherein the orientation of the at least one idler roller and the at least one wheel are modified such that the centerline of the glass web is substantially parallel to the conveyance direction of the web conveyance pathway, and the edge of the glass web is shifted to a predetermined position.

14. A method for producing a glass web comprising:
melting glass batch materials to form molten glass;
forming the molten glass into the glass web with a fusion draw machine comprising an inlet, a forming vessel, and a pull roll assembly;
drawing the glass web through the pull roll assembly;
directing the glass web in a conveyance direction on a web conveyance pathway;
contacting at least one surface of the glass web with at least one wheel of an idler roller, the at least one wheel of the idler roller having an axis of rotation parallel to a surface of the glass web;
detecting an angle between a centerline of the glass web and the conveyance direction with an angle measurement device; and
modifying an orientation of the idler roller and the at least one wheel about an axis of rotation substantially orthogonal to the web conveyance pathway to shift the glass web based on a detected angle between the centerline of the glass web and the conveyance direction of the web conveyance pathway.

15. The method of producing a glass web of claim 14, wherein the idler roller contacts a top surface of the glass web proximate to an edge of the glass web.

16. The method producing a glass web of claim 14, wherein the orientation of the idler roller and the at least one wheel are modified such that the idler roller shifts the glass web to alter the angle between the centerline of the glass web and the conveyance direction of the web conveyance pathway so that the centerline of the glass web is substantially parallel to the conveyance direction of the web conveyance pathway.

17. The method of producing a glass web of claim 14, further comprising detecting the position of an edge of the glass web, and modifying the orientation of the idler roller and the at least one wheel to shift the glass web based on the detected angle between the centerline of the glass web and the conveyance direction and a detected position of the edge of the glass web.

18. The method of producing a glass web of claim 17 wherein the orientation of the idler roller and the at least one wheel are modified such that the centerline of the glass web is substantially parallel to the conveyance direction, and the edge of the glass web is shifted to a predetermined position.

19. The method of producing a glass web of claim 14 further comprising separating thickened edge beads from the glass web with a laser separation machine.

20. The method of producing a glass web of claim 14 wherein the at least one wheel of the at least one idler roller contacts a top surface of the glass web proximate to an edge of the glass web.
